(19) United States
(12) Patent Application Publication
(10) Pub. No.: US 2021/0094588 A1
(43) Pub. Date: Apr. 1, 2021

(54) METHOD FOR PROVIDING CONTENTS OF AUTONOMOUS VEHICLE AND APPARATUS FOR SAME

(71) Applicant: LG ELECTRONICS INC., Seoul (KR)

(72) Inventors: Hyunkyu KIM, Seoul (KR); Kibong SONG, Seoul (KR)

(73) Assignee: LG ELECTRONICS INC., Seoul (KR)

(21) Appl. No.: 16/915,948

(22) Filed: Jun. 29, 2020

(30) Foreign Application Priority Data
Sep. 27, 2019 (KR) 10-2019-0119455

(51) Int. Cl. B60W 60/00; B60W 40/08; G01C 21/34; G06N 3/04; G06N 3/08; G06T 19/00; G06T 7/70

(52) U.S. Cl. CPC B60W 60/00136; B60W 40/08; G01C 21/3407; G06N 3/04; G06N 3/08; B60W 2520/105; G06T 7/70; B60W 2540/225; B60W 2540/22; B60W 2040/0818; G06T 19/00

(57) ABSTRACT

Disclosed is a method and apparatus for providing content by an autonomous vehicle. According to an embodiment of the disclosure, a method for providing content measures user data for playing 3D content and estimates first prediction data indicating a degree of dizziness predicted for the user and second prediction data indicating a degree of carsickness predicted for the user, using a specific algorithm based on the user data. Thereafter, the method adjusts a depth of the 3D content when the first prediction data is larger than a first threshold or the second prediction data is larger than a second threshold and plays the 3D content via the output device based on the adjusted depth. An autonomous vehicle of the present disclosure can be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATIONS

Pursuant to 35 U.S.C. § 119(a), this application claims the benefit of earlier filing date and right of priority to Korean Patent Application No. 10-2019-0119455, filed on Sep. 27, 2019, the contents of which are all hereby incorporated by reference herein in their entirety

### BACKGROUND OF THE DISCLOSURE

### Field of the Disclosure

The present disclosure relates to a method of providing content by an autonomous vehicle and apparatus for the same, and more specifically, to a method for providing, by an autonomous vehicle, 3D content depending on the state of the vehicle or onboard person and apparatus for the same.

### Related Art

Vehicles can be classified into an internal combustion engine vehicle, an external composition engine vehicle, a gas turbine vehicle, an electric vehicle, etc. according to types of motors used therefor.

Recent autonomous vehicles may provide 2D or 3D content to the onboard persons while driving.

However, because the vehicle may keep shaking or vibrating while driving, the persons on board may feel dizzy or carsick while viewing 3D content. Providing 3D content in a driving vehicle may suffer from such drawbacks.

Therefore, a need exists for a method for smoothly providing 3D content to drivers or passengers in autonomous vehicle while driving.

### SUMMARY OF THE DISCLOSURE

The disclosure has been made in an effort to address aforementioned necessities and/or problems.

The disclosure aims to implement a method for providing 3D content while a vehicle is driving.

The disclosure also aims to implement a method for providing 3D content without causing the onboard persons to feel dizzy and/or carsick, considering their positions or states and the playback method of content while the vehicle is driving.

The disclosure also aims to provide a method of playing 3D content in the optimal position of the people in the vehicle using accrued data so as to prevent dizziness and/or carsickness due to 3D content.

According to an embodiment of the present disclosure, a method for providing content by an autonomous vehicle in an autonomous driving system comprises measuring user data for playing three-dimensional (3D) content, the user data including at least one of a position of the user's eye, a first distance between the eye position and the 3D content, a second distance between the eye position and an output device playing the 3D content, an angle between the eye position and the output device, and a type of the 3D content, estimating first prediction data indicating a degree of dizziness predicted for the user and second prediction data indicating a degree of carsickness predicted for the user, using a specific algorithm based on the user data, adjusting a depth of the 3D content when the first prediction data is larger than a first threshold or the second prediction data is larger than a second threshold, and playing the 3D content via the output device based on the adjusted depth, wherein the first threshold indicates a minimum degree of dizziness at which the user feels dizzy, and the second threshold indicates a minimum degree of carsickness at which the user feels carsick.

Further, according to the disclosure, the depth is adjusted until the first prediction data is smaller than the first threshold, and the second prediction data is smaller than the second threshold.

Further, according to the disclosure, the depth is adjusted to allow an adjustment distance indicating an actual distance between the eye and the 3D content to match a convergence distance indicating a distance for focusing the eye on the 3D content.

Further, according to the disclosure, the convergence distance and the adjustment distance are adjusted by altering a disparity of the 3D content.

Further, according to the disclosure, the disparity is altered by changing at least one of the first distance, the second distance, or the angle.

Further, according to the disclosure, the user data includes variable data and invariable data. The variable data includes the first distance, the second distance, and the angle, and the invariable data includes the eye position and the type of the 3D content.

Further, according to the disclosure, the specific algorithm is a deep neural network (DNN) algorithm. The DNN algorithm derives the first threshold and the second threshold by repeated learning based on content playback information and user data measured from existing users.

Further, according to the disclosure, the depth is varied depending on a driving route and driving plan of the autonomous vehicle.

Further, according to the disclosure, the method further comprises estimating a first variation range in which the position of the user's eye is varied according to the driving route, calculating a second variation range of a disparity of the 3D content to minimize the degree of dizziness and the degree of carsickness according to the first variation range using the specific algorithm, and changing the disparity by a predetermined time and/or predetermined distance interval, within the second variation range, based on a speed and/or acceleration of the autonomous vehicle.

Further, according to the disclosure, if the disparity is frequently varied or the second variation range is impossible to calculate, the 3D content is changed into two-dimensional (2D) content, or the 3D content is output via a different output device.

According to the disclosure, an autonomous vehicle for providing content in an autonomous driving system comprises a plurality of output devices for playing 3D content, a transmitter and a receiver for communicating with a server, and a processor functionally connected with the transmitter and the receiver, wherein the processor measures user data for playing the 3D content, the user data including at least one of a position of the user's eye, a first distance between the eye position and the 3D content, a second distance between the eye position and an output device playing the 3D content, an angle between the eye position and the output device, and a type of the 3D content, estimates first prediction data indicating a degree of dizziness predicted for the user and second prediction data indicating a degree of carsickness predicted for the user, using a specific algorithm based on the user data, adjusts a depth of the 3D content when the first prediction data is larger than a first threshold or the second prediction data is larger than a second threshold, and plays the 3D content via the output devices based on the adjusted depth, wherein the first threshold indicates a minimum degree of dizziness at which the user feels dizzy, and the second threshold indicates a minimum degree of carsickness at which the user feels carsick.

### BRIEF DESCRIPTION OF THE DRAWINGS

Accompanying drawings included as a part of the detailed description for helping understand the present disclosure provide embodiments of the present disclosure and are provided to describe technical features of the present disclosure with the detailed description.

Accompanying drawings included as a part of the detailed description for helping understand the present disclosure provide embodiments of the present disclosure and are provided to describe technical features of the present disclosure with the detailed description.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a block diagram of an AI device according to an embodiment of the present disclosure.

FIG. 7 is a diagram for illustrating a system in which an autonomous vehicle and an AI device according to an embodiment of the present disclosure are linked.

FIG. 8 is a control block diagram of the vehicle according to an embodiment of the present disclosure.

FIG. 9 is a control block diagram of an autonomous device according to an embodiment of the present disclosure.

FIG. 10 is a diagram showing a signal flow in an autonomous vehicle according to an embodiment of the present disclosure.

FIG. 11 is a diagram illustrating the interior of a vehicle according to an embodiment of the present disclosure.

FIG. 12 is a block diagram referred to in description of a cabin system for a vehicle according to an embodiment of the present disclosure.

FIG. 13 is a diagram referred to in description of a usage scenario of a user according to an embodiment of the present disclosure.

FIG. 14 is a flowchart illustrating an example method for playing content while an autonomous vehicle is driving according to an embodiment of the present disclosure.

FIG. 15 is a flowchart illustrating an example method for adjusting the depth of 3D content via an algorithm according to an embodiment of the present disclosure.

FIG. 16 is a view illustrating an example algorithm for predicting and deriving a user's state using user data according to an embodiment of the present disclosure.

FIGS. 17 and 18 are views illustrating an example method for measuring user data according to an embodiment of the present disclosure.

FIG. 19 is a view illustrating an example method for predicting and deriving a user's state using measured user data according to an embodiment of the present disclosure.

FIG. 20 is a view illustrating an example method for changing a user's state to an optimal state using a value derived via an algorithm according to an embodiment of the present disclosure.

FIGS. 21 and 22 are views illustrating an example method for changing the depth of 3D content according to an embodiment of the present disclosure.

FIGS. 23 and 24 are views illustrating an example method for changing the depth of 3D content depending on a driving route and driving state of an autonomous vehicle according to an embodiment of the present disclosure.

FIGS. 25 and 26 are views illustrating an example method for changing a position for playing 3D content or 3D content to 2D content depending on a user's state according to an embodiment of the present disclosure.

Attached drawings, which are included as a part of the detailed description to facilitate understanding of the disclosure, provide examples of embodiments for the disclosure, and describe technical features of the disclosure together with the detailed description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

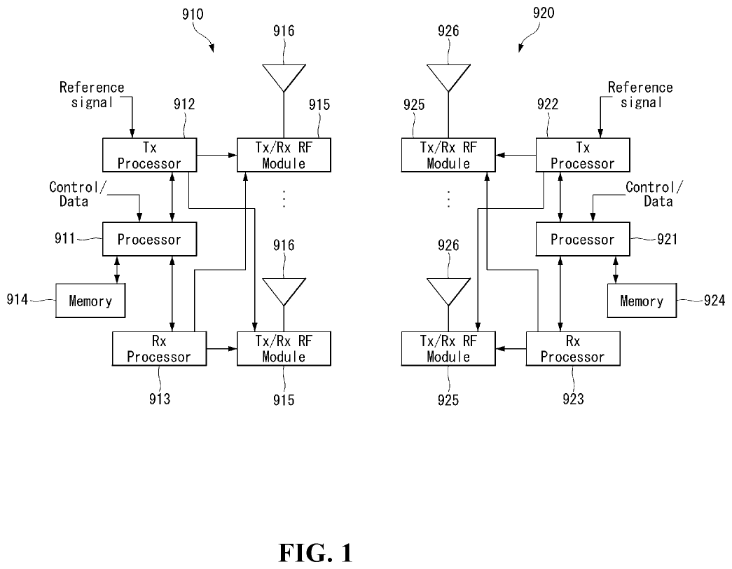

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

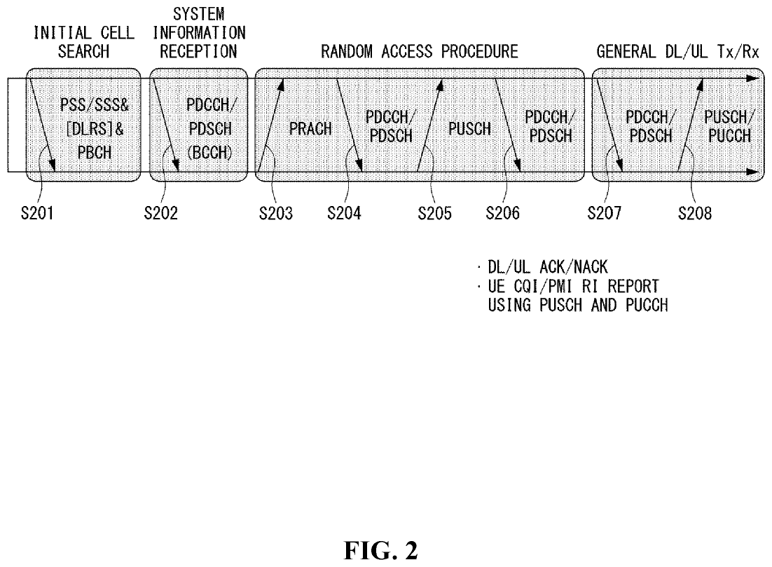

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlockl) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC

parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

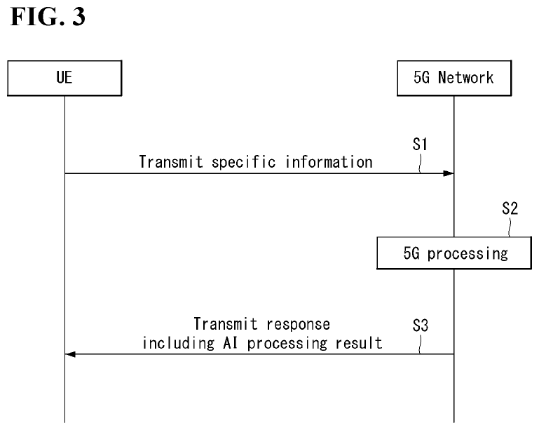

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

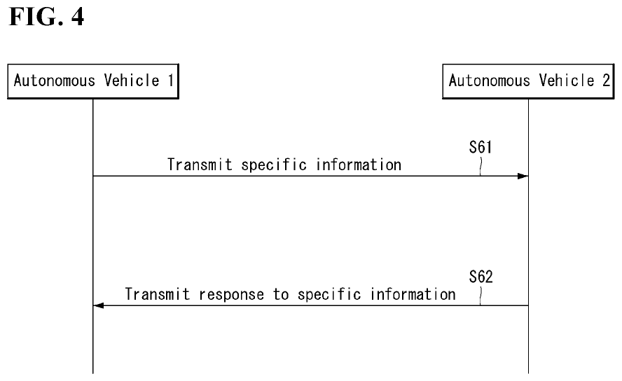

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

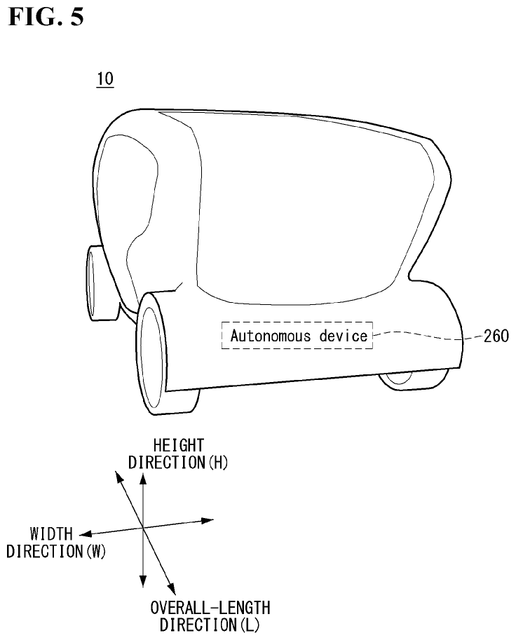

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

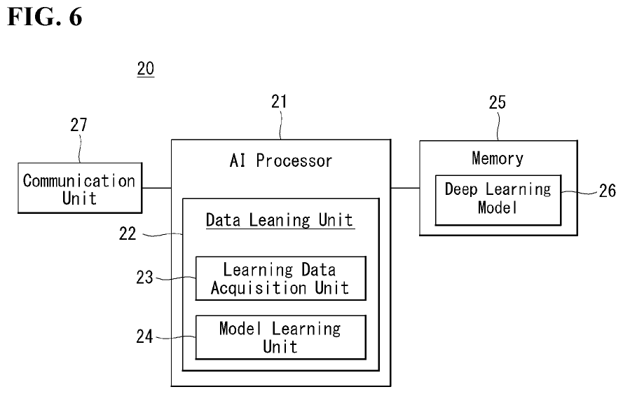

FIG. 6 is a block diagram of an AI device according to an embodiment of the present disclosure.

An AI device 20 may include an electronic device including an AI module that can perform AI processing, a server including the AI module, or the like. Further, the AI device 20 may be included as at least one component of the vehicle 10 shown in FIG. 1 to perform together at least a portion of the AI processing.

The AI processing may include all operations related to driving of the vehicle 10 shown in FIG. 5. For example, an autonomous vehicle can perform operations of processing/determining, and control signal generating by performing AI processing on sensing data or driver data. Further, for example, an autonomous vehicle can perform autonomous driving control by performing AI processing on data acquired through interaction with other electronic devices included in the vehicle.

The AI device 20 may include an AI processor 21, a memory 25, and/or a communication unit 27.

The AI device 20, which is a computing device that can learn a neural network, may be implemented as various electronic devices such as a server, a desktop PC, a notebook PC, and a tablet PC.

The AI processor 21 can learn a neural network using programs stored in the memory 25. In particular, the AI processor 21 can learn a neural network for recognizing data related to vehicles. Here, the neural network for recognizing data related to vehicles may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present disclosure.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and by applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquiring unit 23 can acquire learning data required for a neural network model for classifying and recognizing data. For example, the learning data acquiring unit 23 can acquire, as learning data, vehicle data and/or sample data to be input to a neural network model.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

Further, the learning data selector can select data for learning from the learning data acquired by the learning data acquiring unit 23 or the learning data preprocessed by the preprocessor. The selected learning data can be provided to the model learning unit 24. For example, the learning data selector can select only data for objects included in a specific area as learning data by detecting the specific area in an image acquired through a camera of a vehicle.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 6 was functionally separately described into the AI processor 21, the memory 25, the communication unit 27, etc., but it should be noted that the aforementioned components may be integrated in one module and referred to as an AI module.

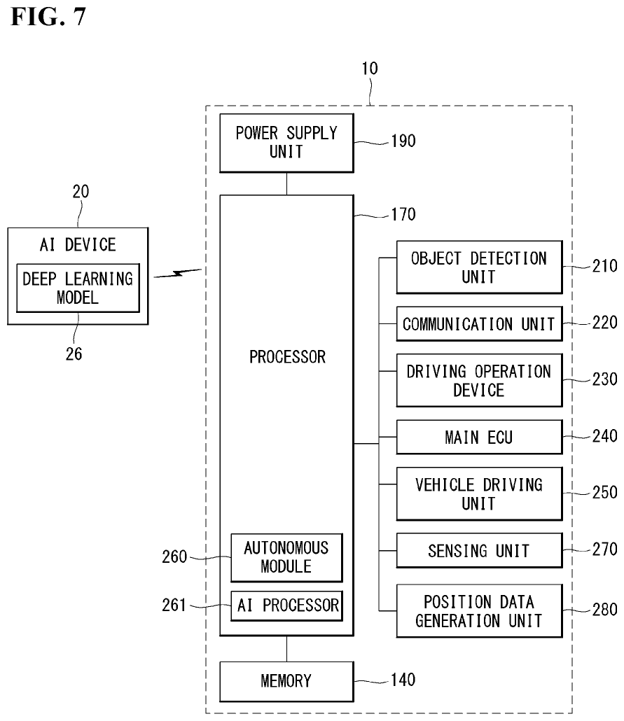

FIG. 7 is a diagram for illustrating a system in which an autonomous vehicle and an AI device according to an embodiment of the present disclosure are linked.

Referring to FIG. 7, an autonomous vehicle 10 can transmit data that require AI processing to an AI device 20 through a communication unit and the AI device 20 including a neural network model 26 can transmit an AI processing result using the neural network model 26 to the autonomous vehicle 10. The description of FIG. 2 can be referred to for the AI device 20.

The autonomous vehicle 10 may include a memory 140, a processor 170, and a power supply 170 and the processor 170 may further include an autonomous module 260 and an AI processor 261. Further, the autonomous vehicle 10 may include an interface that is connected with at least one electronic device included in the vehicle in a wired or wireless manner and can exchange data for autonomous driving control. At least one electronic device connected through the interface may include an object detection unit 210, a communication unit 220, a driving operation unit 230, a main ECU 240, a vehicle driving unit 250, a sensing unit 270, and a position data generation unit 280.

The interface can be configured using at least one of a communication module, a terminal, a pin, a cable, a port, a circuit, an element, and a device.

The memory 140 is electrically connected with the processor 170. The memory 140 can store basic data about units, control data for operation control of units, and input/output data. The memory 140 can store data processed in the processor 170. Hardware-wise, the memory 140 may be configured using at least one of a ROM, a RAM, an EPROM, a flash drive and a hard drive. The memory 140 can store various types of data for the overall operation of the autonomous vehicle 10, such as a program for processing or control of the processor 170. The memory 140 may be integrated with the processor 170. Depending on embodiments, the memory 140 may be classified as a lower configuration of the processor 170.

The power supply 190 can supply power to the autonomous vehicle 10. The power supply 190 can be provided with power from a power source (e.g., a battery) included in the autonomous vehicle 10 and can supply the power to each unit of the autonomous vehicle 10. The power supply 190 can operate according to a control signal supplied from the main ECU 240. The power supply 190 may include a switched-mode power supply (SMPS).

The processor 170 can be electrically connected to the memory 140, the interface 180, and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal, and provide the signal while power is supplied thereto by the power supply 190.

The processor 170 can receive information from other electronic devices included in the autonomous vehicle 10 through the interface. The processor 170 can provide control signals to other electronic devices in the autonomous vehicle 10 through the interface.

The autonomous device 10 may include at least one printed circuit board (PCB). The memory 140, the interface, the power supply 190, and the processor 170 may be electrically connected to the PCB.

Hereafter, other electronic devices connected with the interface and included in the vehicle, the AI processor 261, and the autonomous module 260 will be described in more detail. Hereafter, for the convenience of description, the autonomous vehicle 10 is referred to as a vehicle 10.

First, the object detection unit 210 can generate information on objects outside the vehicle 10. The AI processor 261 can generate at least one of on presence or absence of an object, positional information of the object, information on a distance between the vehicle and the object, and information on a relative speed of the vehicle with respect to the object by applying data acquired through the object detection unit 210 to a neural network model.

The object detection unit 210 may include at least one sensor that can detect objects outside the vehicle 10. The sensor may include at least one of a camera, a radar, a lidar, an ultrasonic sensor, and an infrared sensor. The object detection unit 210 can provide data about an object generated on the basis of a sensing signal generated from a sensor to at least one electronic device included in the vehicle.

Meanwhile, the vehicle 10 transmits the sensing data acquired through at least one sensor to the AI device 20 through the communication unit 220 and the AI device 20 can transmit AI processing data by applying the neural network model 26 to the transmitted data to the vehicle 10. The vehicle 10 recognizes information about the detected object on the basis of the received AI processing data and the autonomous module 260 can perform an autonomous driving control operation using the recognized information.

The communication unit 220 can exchange signals with devices disposed outside the vehicle 10. The communication unit 220 can exchange signals with at least any one of an infrastructure (e.g., a server and a broadcast station), another vehicle, and a terminal. The communication unit 220 may include at least any one of a transmission antenna, a reception antenna, a radio frequency (RF) circuit which can implement various communication protocols, and an RF element in order to perform communication.

It is possible to generate at least one of on presence or absence of an object, positional information of the object, information on a distance between the vehicle and the object, and information on a relative speed of the vehicle with respect to the object by applying data acquired through the object detection unit 210 to a neural network model.

The driving operation unit 230 is a device for receiving user input for driving. In a manual mode, the vehicle 10 may be driven on the basis of a signal provided by the driving operation unit 230. The driving operation unit 230 may include a steering input device (e.g., a steering wheel), an acceleration input device (e.g., an accelerator pedal), and a brake input device (e.g., a brake pedal).

Meanwhile, the AI processor 261, in an autonomous mode, can generate an input signal of the driving operation unit 230 in accordance with a signal for controlling movement of the vehicle according to a driving plan generated through the autonomous module 260.

Meanwhile, the vehicle 10 transmits data for control of the driving operation unit 230 to the AI device 20 through the communication unit 220 and the AI device 20 can transmit AI processing data generated by applying the neural network model 26 to the transmitted data to the vehicle 10. The vehicle 10 can use the input signal of the driving operation unit 230 to control movement of the vehicle on the basis of the received AI processing data.

The main ECU 240 can control the overall operation of at least one electronic device included in the vehicle 10.

The vehicle driving unit 250 is a device for electrically controlling various vehicle driving devices included in the vehicle 10. The vehicle driving unit 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device, and a suspension driving control device. Meanwhile, the safety device driving control device may include a seatbelt driving control device for seatbelt control.

The vehicle driving unit 250 includes at least one electronic control device (e.g., a control ECU (Electronic Control Unit)).

The vehicle driving unit 250 can control a power train, a steering device, and a brake device on the basis of signals received by the autonomous module 260. The signals received by the autonomous module 260 may be driving control signals that are generated by applying a neural network model to data related to the vehicle in the AI processor 261. The driving control signals may be signals received from the external AI device 20 through the communication unit 220.

The sensing unit 270 can sense a state of the vehicle. The sensing unit 270 may include at least any one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor, and a magnetic sensor.

The AI processor 261 can generate state data of the vehicle by applying a neural network model to sensing data generated by at least one sensor. The AI processing data generated by applying the neural network model may include vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an accelerator pedal, data of a pressure applied to a brake pedal, etc.

The autonomous module 260 can generate a driving control signal on the basis of the AI-processed state data of the vehicle.

Meanwhile, the vehicle 10 transmits the sensing data acquired through at least one sensor to the AI device 20 through the communication unit 22 and the AI device 20 can transmit AI processing data generated by applying the neural network model 26 to the transmitted data to the vehicle 10.

The position data generation unit 280 can generate position data of the vehicle 10. The position data generation unit 280 may include at least any one of a global positioning system (GPS) and a differential global positioning system (DGPS).

The AI processor 261 can generate more accurate position data of the vehicle by applying a neural network model to position data generated by at least one position data generation device.

In accordance with an embodiment, the AI processor 261 can perform deep learning calculation on the basis of at least any one of the internal measurement unit (IMU) of the sensing unit 270 and the camera image of the object detection unit 210 and can correct position data on the basis of the generated AI processing data.

Meanwhile, the vehicle 10 transmits the position data acquired from the position data generation unit 280 to the AI device 20 through the communication unit 220 and the AI device 20 can transmit the AI processing data generated by applying the neural network model 26 to the received position data to the vehicle 10.

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

The autonomous module 260 can generate a route for autonomous driving and a driving plan for driving along the generated route on the basis of the acquired data.

The autonomous module 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring), and TJA (Traffic Jam Assist).

The AI processor 261 can transmit control signals that can perform at least one of the ADAS functions described above to the autonomous module 260 by applying traffic-related information received from at least one sensor included in the vehicle and external devices and information received from another vehicle communicating with the vehicle to a neural network model.

Further, the vehicle 10 transmits at least one data for performing the ADAS functions to the AI device 20 through the communication unit 220 and the AI device 20 can transmit the control signal that can perform the ADAS functions to the vehicle 10 by applying the neural network model 260 to the received data.

The autonomous module 260 can acquire state information of a driver and/or state information of a vehicle through the AI processor 261 and can perform switching from an autonomous mode to a manual driving mode or switching from the manual driving mode to the autonomous mode.

Meanwhile, the vehicle 10 can use AI processing data for passenger support for driving control. For example, as described above, it is possible to check the states of a driver and passengers through at least one sensor included in the vehicle.

Alternatively, the vehicle 10 can recognize voice signals of a driver or passengers, perform a voice processing operation, and perform a voice synthesis operation through the AI processor 261.

5G communication for implementing the vehicle control method according to an embodiment of the present disclosure and schematic contents for performing AI processing by applying the 5G communication and for transmitting/receiving the AI processing result were described above.

Hereafter, a detailed method of passively intervening or actively intervening in a careless state of a driver on the basis of state information of the driver in accordance with an embodiment of the present disclosure is described with reference to necessary drawings.

(2) Components of Vehicle

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

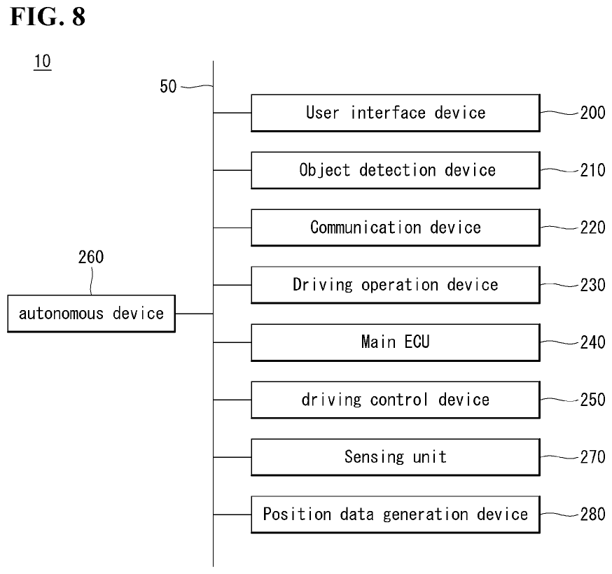

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

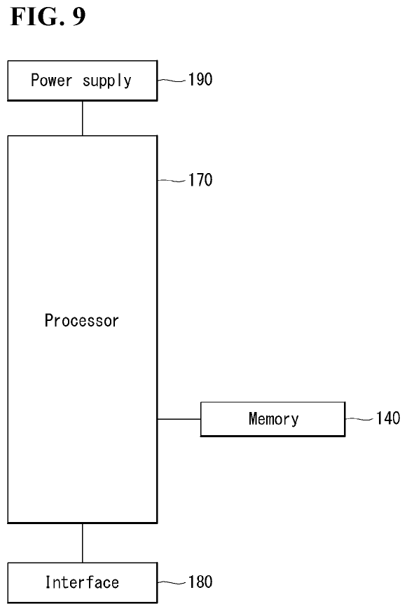

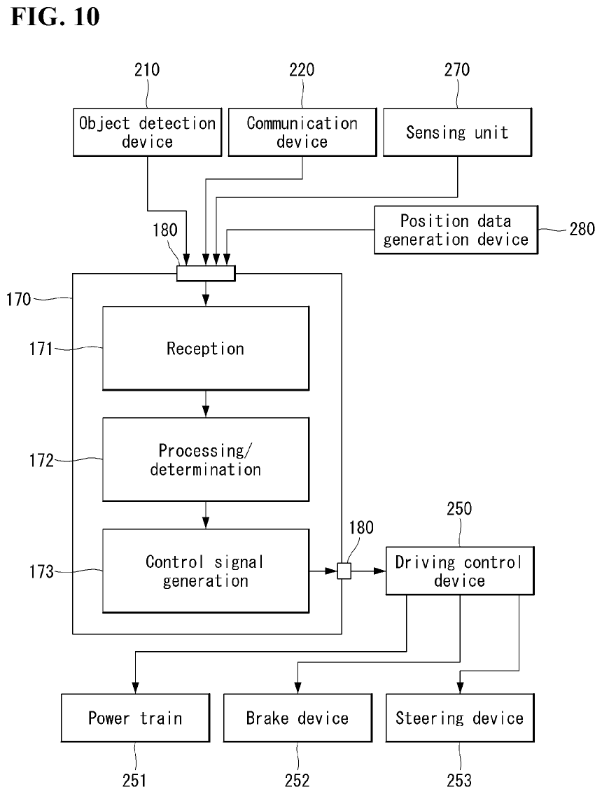

FIG. 9 is a diagram showing the interior of the vehicle according to an embodiment of the present disclosure. FIG. 10 is a block diagram referred to in description of a cabin system for a vehicle according to an embodiment of the present disclosure.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

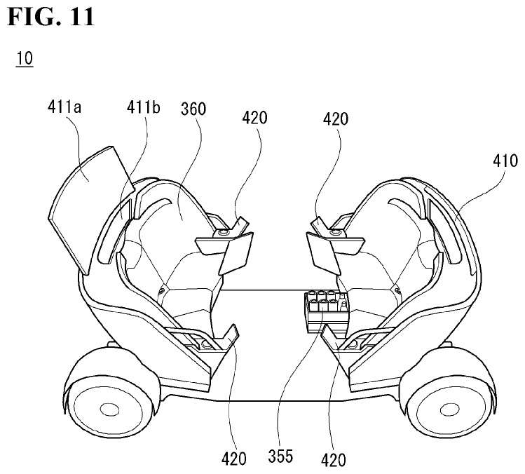

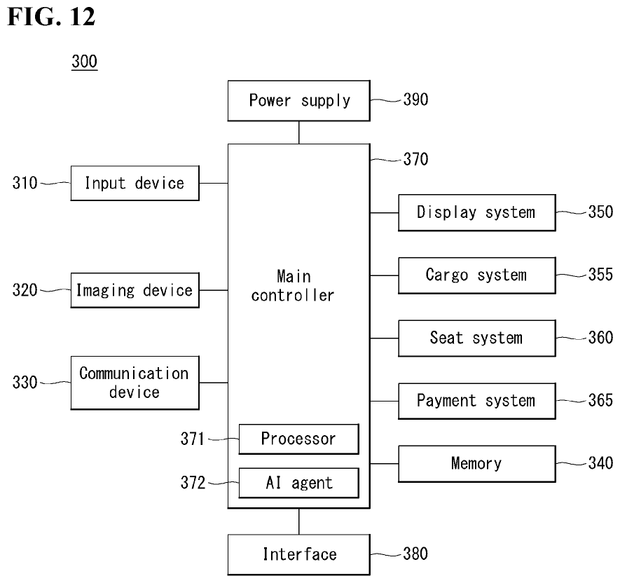

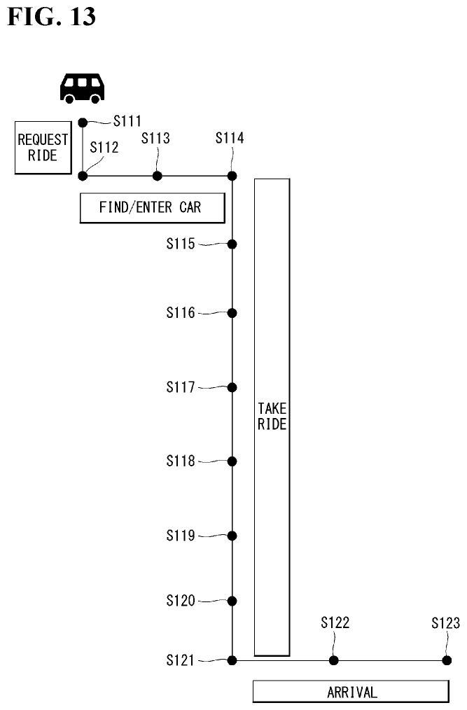

FIG. 11 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present disclosure which will be described later and applied or can complement the methods proposed in the present disclosure to make technical features of the present disclosure concrete and clear.

Hereinafter, various embodiments of the present disclosure will be described in detail with reference to the attached drawings.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

Furthermore, although the disclosure has been described with reference to the exemplary embodiments, those skilled in the art will appreciate that various modifications and variations can be made in the present disclosure without departing from the spirit or scope of the disclosure described in the appended claims. For example, each component described in detail in embodiments can be modified. In addition, differences related to such modifications and applications should be interpreted as being included in the scope of the present disclosure defined by the appended claims.

Although description has been made focusing on examples in which the present disclosure is applied to automated vehicle & highway systems based on 5G (5 generation) system, the present disclosure is also applicable to various wireless communication systems and autonomous devices.

Hereinafter, a specific method for monitoring a person in a vehicle to minimize the dizziness and/or carsickness of the person while viewing 3D content while the vehicle is driving, according to an embodiment, is described below with reference to the drawings.

Hereinafter, a person on board an autonomous vehicle or an onboard person may also be referred to as a passenger or user.

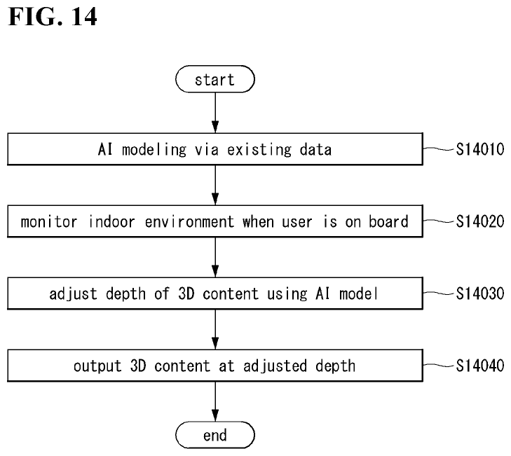

FIG. 14 is a flowchart illustrating an example method for playing content while an autonomous vehicle is driving according to an embodiment of the present disclosure.

Referring to FIG. 14, an autonomous vehicle may change content providing schemes depending on the state of the persons on board while providing content using a display system to the onboard persons.

Specifically, when the autonomous vehicle provides services using, e.g., 3D content, using output devices (e.g., a display system or an audio system) while driving, the 3D content may cause some passengers to feel dizzy or carsick.

In providing 3D content while the autonomous vehicle is driving, the autonomous vehicle may model a specific algorithm to identify (or predict) the degree of dizziness and/or carsickness the passenger feels using a preexisting database and apply the user's monitoring data to the modeled algorithm, thereby deriving prediction data.

Thereafter, a content providing method for minimizing the passenger's dizziness and/or carsickness via pre-trained modeling based on the prediction data may be derived, and 3D content may be provided to the onboard persons.

In this case, as the specific algorithm, AI modeling (e.g., a deep neural network algorithm) may be used and, for the monitoring data, an indoor environment monitoring system (e.g., an interior monitoring system (IMS)) may be put to use.

Deep neural network (DNN) algorithm may mean an artificial neural network (ANN) consisting of an input layer, an output layer, and several hidden layers between the input layer and the output layer. The DNN may model complicated non-linear relationships as does the normal artificial neural networks. For example, in a DNN structure for object identification modeling, each object may be represented as a hierarchical configuration of basic elements of the image. In this case, additional layers may merge the features of lower layers that gradually come together. Such nature of the DNN enables modeling of complicated data only with a fewer units (or nodes) than an ANN that works similarly.

User data may include at least one of the position of the user's eye, the distance (first distance) between the eye position and 3D content, the distance (second distance) between the eye position and the output device playing the 3D content, the angle between the eye position and the output device, and the type of 3D content.

First, the autonomous vehicle performs AI modeling via a specific algorithm using existing data (S14010). In other words, modeling for identifying the degree of dizziness and/or carsickness the passenger feels using the passenger's preexisting user data as input data may be carried out.

Then, as the user is on board, the autonomous vehicle may monitor the indoor environment (S14020). The monitoring of indoor environment may be performed via an IMS, and user data may be obtained by monitoring.

The user data may be varied depending on the 3D content being provided to the user, the passenger's height and sitting height and, depending on the variation in the passenger's eye position along the driving route of the autonomous vehicle, the distance or angle between the passenger's eye and the 3D content may be measured and obtained.

Then, the depth of 3D content may be adjusted using the modeled AI model, and 3D content may be provided in the adjusted depth (S14040).

The user's degree of dizziness (first prediction data) and/or degree of carsickness (second prediction data) may be predicted based on the user data upon providing the 3D content using the AI modeling so as to adjust the depth of the 3D content using the AI model.

Thereafter, a first threshold which indicates the minimum degree of dizziness the user may feel when the 3D content is provided and a second threshold which indicates the minimum degree of carsickness the user may feel may be derived via the AI model using the existing passenger data as input data.

Upon determining that the passenger feels dizzy and/or carsick based on the first threshold and the second threshold, the depth of the 3D content and/or the position of the display device of the display system may be changed so that the first prediction data is smaller than the first threshold, and the second prediction data is smaller than the second threshold.

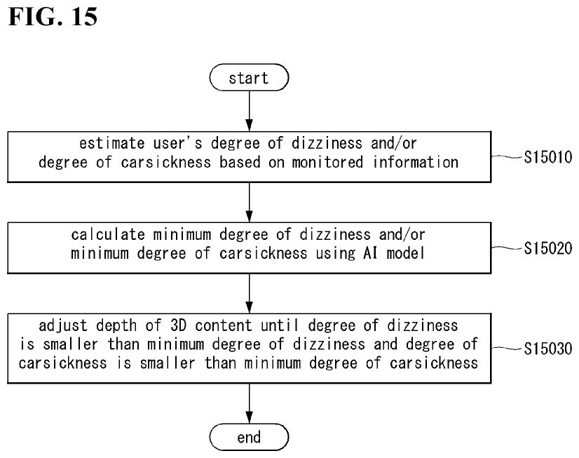

FIG. 15 is a flowchart illustrating an example method for adjusting the depth of 3D content via an algorithm according to an embodiment of the present disclosure.

Referring to FIG. 15, if the 3D content provided while the autonomous vehicle is driving causes the user to feel dizzy or carsick, the depth of the 3D content may be varied.

Specifically, it may be possible to obtain the passenger's user data by the method described above in connection with FIG. 14 and to model an AI model for predicting the passenger's degree of dizziness and/or degree of carsickness using a specific algorithm based on a preexisting database.

Thereafter, the degree of dizziness (first prediction data) and/or degree of carsickness (second prediction data) predicted for the user when 3D content is provided may be estimated by applying user data measured using an indoor environment measuring system to the modeled AI model (S15010).

A first threshold which indicates the minimum degree of dizziness the user may feel and a second threshold which indicates the minimum degree of carsickness the user may feel when the 3D content is provided may be obtained using the AI model, based on the existing user data so as to determine the passenger's degree of dizziness and/or degree of carsickness based on the first prediction data and the second prediction data (S15020).

Then, it is determined whether the passenger may feel dizzy or carsick while receiving the 3D content by comparing the first prediction data with the first threshold and comparing the second prediction data with the second threshold.

If the first prediction data is smaller than the first threshold, and the second prediction data is smaller than the second threshold, the passenger is determined to be less likely to feel dizzy or carsick even when viewing 3D content, and thus, the depth of 3D content is not adjusted.

However, if the first prediction data is larger than the first threshold, and the second prediction data is larger than the second threshold, the passenger is determined to be highly likely to feel dizzy or carsick even when viewing 3D content, and thus, the depth of 3D content may be not adjusted (S15030).

A method for adjusting the depth of content is described below.

Use of this method enables the autonomous vehicle to monitor the state of each passenger and provide the optimal 3D content, allowing the passenger to view the 3D content without dizziness or carsickness.

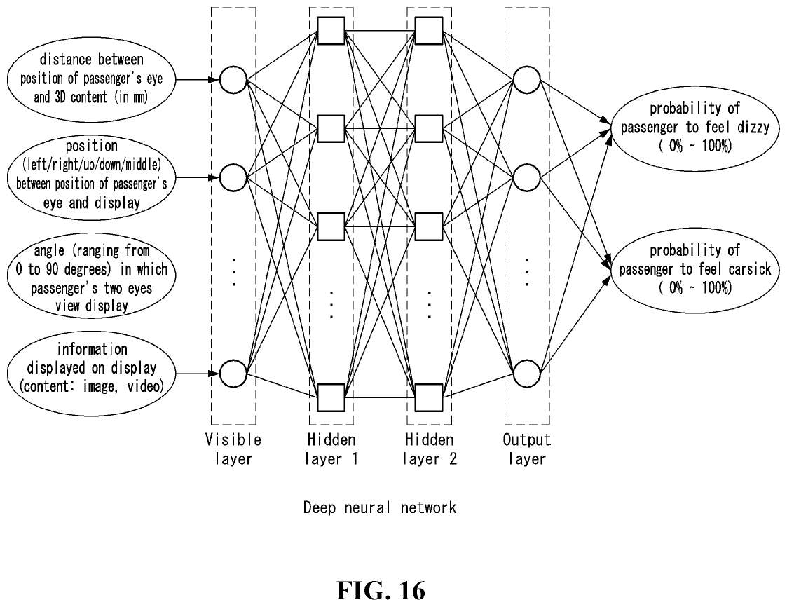

FIG. 16 is a view illustrating an example algorithm for predicting and deriving a user's state using user data according to an embodiment of the present disclosure.

Referring to FIG. 16, the user's degree of dizziness and/or degree of carsickness may be derived upon providing 3D content according to user data, using prior user data.

Specifically, it is possible to model an AI model for identifying the passenger's dizziness by repeatedly deriving the probability of dizziness, which is the passenger's degree of dizziness, and the probability of carsickness, which is the passenger's degree of carsickness, using the prior-measured user data as input value in a specific algorithm, e.g., a DNN.

In other words, an AI model for identifying the passenger's degree of dizziness may be modeled by repeatedly inputting prior-monitored user data with different values as input values and repeatedly deriving the user's degree of dizziness and/or degree of carsickness.

In this case, as the specific algorithm, the above-described DNN may be used, and several hidden layers may be included between a plurality of input layers to which the user data is input and an output layer which outputs the degree of dizziness and the degree of carsickness.

As the user data input to the visible layer, which is the input layer, a plurality of parameters which may be measured via an indoor environment measurement service may be input between the user and the 3D content.

For example, as shown in FIG. 16, the distance (in millimeters) between the position of the passenger's eye (eyeball) and the 3D content, a position (or distance) between the position of the passenger's eye and the display for outputting 3D content, the angle (ranging from 0 degrees to 90 degrees) in which the passenger's eyes gaze at the display, and information for the 3D content (e.g., images or video) displayed on the display, as the user data, may be input to the input layer.

In this case, the position (or distance) between the position of the passenger's eye and the display for outputting 3D content may be represented as left, right, up, down, middle (or east, west, north, or center) so as to indicate the position.

The parameter values for the minimum degree of dizziness and/or degree of carsickness may be derived by repeatedly deriving the degree of dizziness, which is the probability for the user to feel dizzy, and/or the degree of carsickness, which is the probability for the user to feel carsick, whenever each parameter values is varied via the user data.

In other words, the optimal user data for deriving the minimum degree of dizziness and/or degree of carsickness may be derived by repeated learning.

As such, the optimal parameter values for providing 3D content while driving may be derived by repeatedly inputting preexisting user data and eliciting values using a specific AI algorithm, such as a DNN.

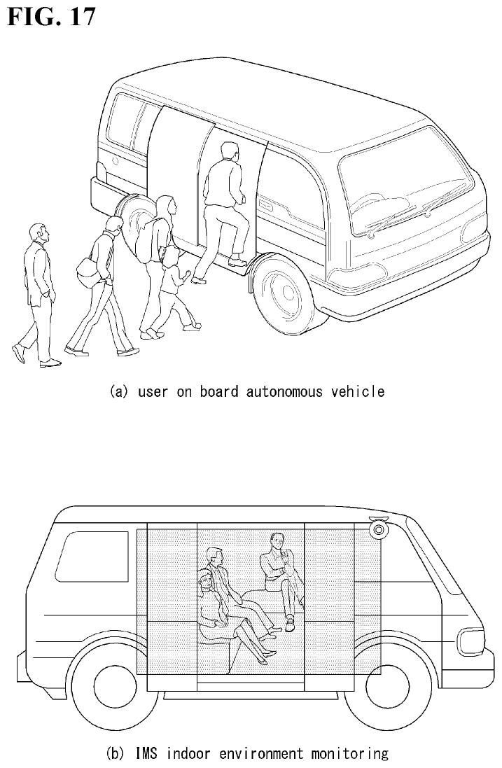

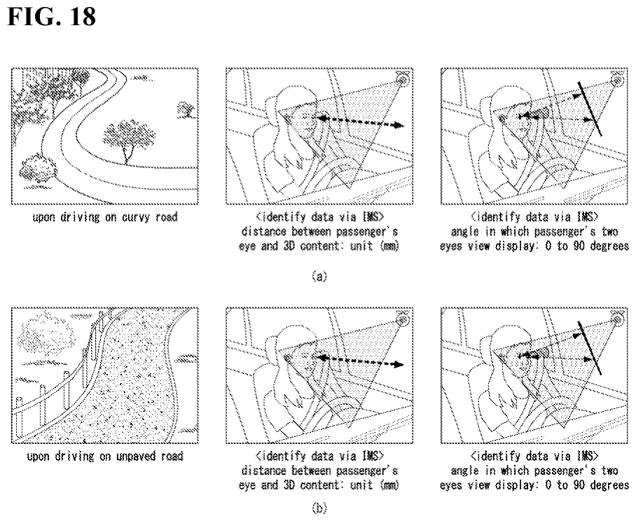

FIGS. 17 and 18 are views illustrating an example method for measuring user data according to an embodiment of the present disclosure.

FIG. 17 illustrates an example measurement range in which user data is measured using a monitoring system when persons are on board the autonomous vehicle. FIG. 18 illustrates an example method for measuring user data using a monitoring system while driving.

Referring to FIG. 17, if passengers are on board on the autonomous vehicle as shown in FIG. 17(a), user data may be measured via an indoor monitoring system (IMS) for monitoring the indoor environment as shown in FIG. 17(b).

For the user data, various parameters between the onboard person and 3D content may be measured to elicit the optimal parameter values to provide 3D content via a specific algorithm as described above.

For example, as set forth above, the distance (in millimeters) between the position of the passenger's eye (eyeball) and the 3D content, a position (or distance) between the position of the passenger's eye and the display for outputting 3D content, the angle (ranging from 0 degrees to 90 degrees) in which the passenger's eyes gaze at the display, and information for the 3D content (e.g., images or video) displayed on the display, as the user data, may be measured.

In this case, the position (or distance) between the position of the passenger's eye and the display for outputting 3D content may be represented as left, right, up, down, middle (or east, west, north, or center) so as to indicate the position.

Such user data may be used to predict the degree of dizziness or degree of carsickness when the user views the 3D content via the AI model modeled by the specific algorithm.

The measured user data may also be used to model an AI model via the specific algorithm.

In other words, the optimal parameter values for providing the user with 3D content may be elicited by repeatedly obtaining resultant values using the prior-measured user data as input values in the specific algorithm as described above in connection with FIG. 16.

If the autonomous vehicle is driving, the user data may be measured considering the driving route as shown in FIG. 18.

In other words, if the autonomous vehicle drives on a curved road as shown in FIG. 18(a), the distance between the passenger's eye and the 3D content may be measured in millimeters via the indoor environment measurement system, i.e., IMS, and the angle between the passenger's eye and the display may be measured within a range from 0 degrees to 90 degrees. The measured parameters may be stored, with the driving route considered.

Since the vehicle's vibrations or shaking may be frequent on a unpaved road as shown in FIG. 18(b), the distance between the user's eye and display and the angle from the display may be varied often.

Thus, the indoor environment measurement system may measure, in millimeters, the distance between the passenger's eye and the 3D content considering the driving route and may measure the angle between the passenger's eye and the display within a range from 0 degrees to 90 degrees.

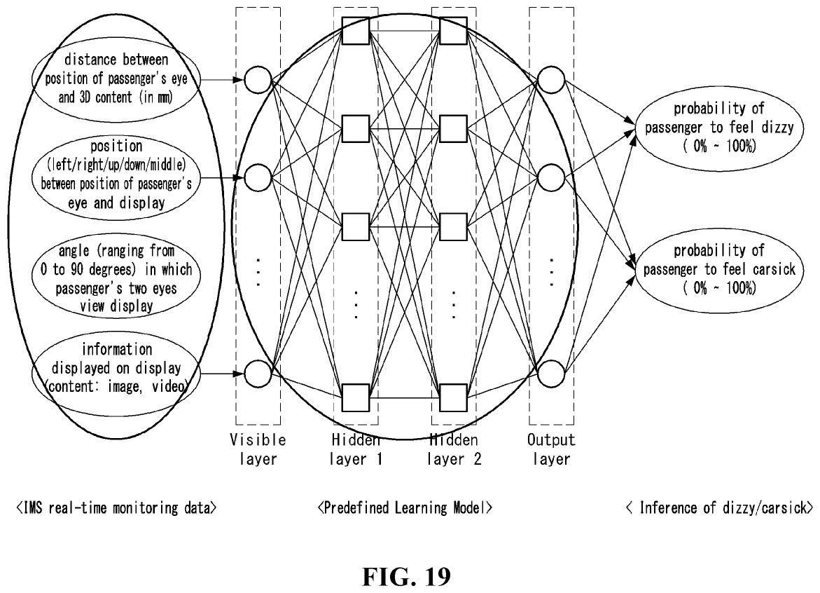

FIG. 19 is a view illustrating an example method for predicting and deriving a user's state using measured user data according to an embodiment of the present disclosure.

Referring to FIG. 19, it is possible to obtain the degree of dizziness and/or degree of carsickness that may arise when the user views 3D content by applying user data measured by the indoor environment measurement system to an AI model modeled using user data prior-measured using a specific algorithm.

For example, as shown in FIG. 19, the user data measured by the indoor environment measurement service, such as the distance (in millimeters, first distance) between the position of the passenger's eye (eyeball) and the 3D content, a position (or distance, second distance) between the position of the passenger's eye and the display for outputting 3D content, the angle (ranging from 0 degrees to 90 degrees) in which the passenger's eyes view the display, and information (e.g., images and/or video) for the 3D content displayed on the display, is input via the input layer of the pre-trained AI model, first prediction data which is the degree of dizziness related to the probability for the user to feel dizzy, and/or second prediction data which is the degree of carsickness related to the probability for the user to feel carsick may be derived via the output layer.

Thereafter, if 3D content is provided to the user based on the derived data, the likelihood of the user to feel dizzy and/or carsick may be inferred, and whether to provide content and whether the user data is varied may be determined based on the inferred value.

In the scenario case shown in FIG. 19, since the first prediction data is 90%, and the second prediction data is 50%, if the user currently views 3D content, the probability of the user to feel dizzy and/or carsick may be increased.

In this case, if 3D content is provided to the user, the user may be highly likely to feel dizzy and/or carsick. Thus, it may be required to stop providing the content or to change how to provide content or the user data.

Such a method is described below.

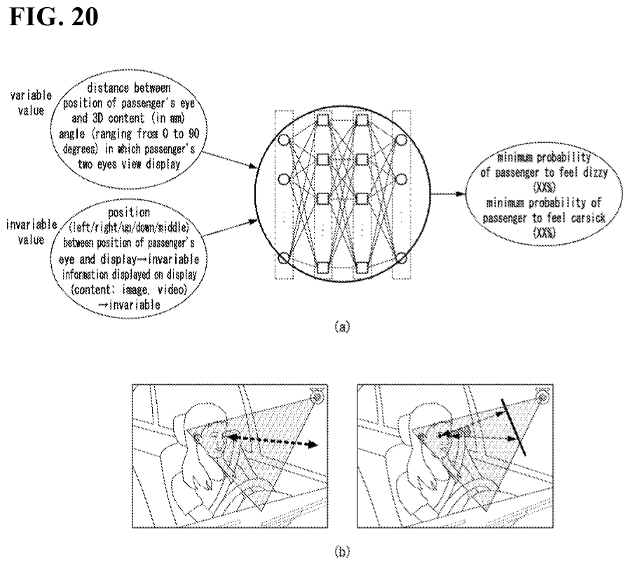

FIG. 20 is a view illustrating an example method for changing a user's state to an optimal state using a value derived via an algorithm according to an embodiment of the present disclosure.

Referring to FIG. 20, the minimum degree of dizziness and/or degree of carsickness of the passenger may be derived using a pre-trained AI model, and user data may be varied based on the derived value.

Specifically, the depth of the 3D content output on the display may be changed based on a position between the display for providing 3D content and the eyes of the passenger currently on board the autonomous vehicle and/or the angle and distance between the 3d and the eyes, at which the degree of dizziness and/or degree of carsickness may be minimized, as shown in FIG. 20(a).

In this case, the user data may include variable data and invariable data. The variable data may include the first distance, the second distance, and the angle, and the invariable data may include the position between the eye and the display, and the type of 3D content related to information displayed on the display.

The passenger's minimum degree of dizziness and/or degree of carsickness may be calculated by the AI model based on the invariable data, and the variable data therefor may be elicited.

In other words, since the invariable data is impossible to vary, the minimum degree of dizziness and/or degree of carsickness, which may be derived based on the invariable data, may be calculated via the AI model, in which case the variable data may be elicited.

For example, as shown in FIG. 20(b), among the pieces of variable data, the first distance and angle corresponding to the first threshold, which is the minimum degree of dizziness, and the second threshold, which is the minimum degree of carsickness, may be derived as 114 mm and 11 degrees, respectively, based on the invariable data calculated by the AI model.

The derived variable data may be applied to reduce the first prediction data and the second prediction data and, by so doing, the depth of 3D content may be adjusted.

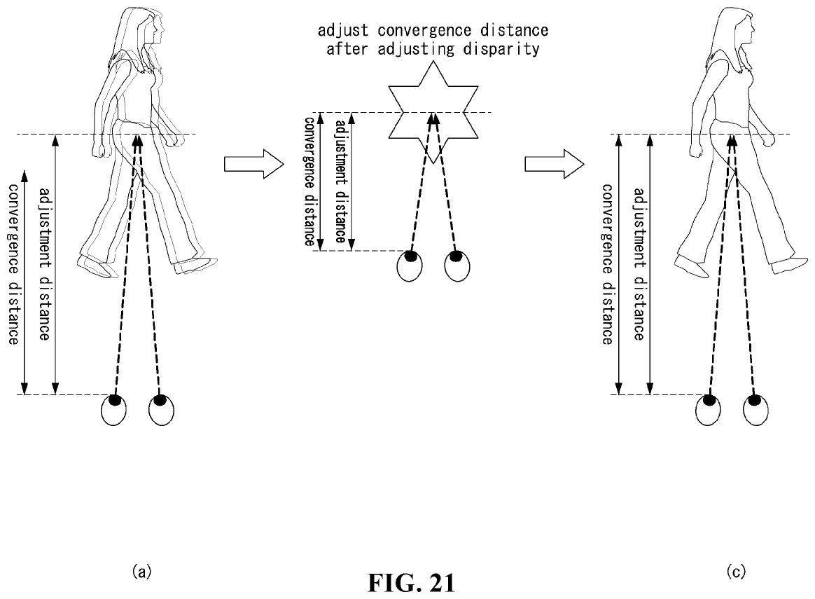

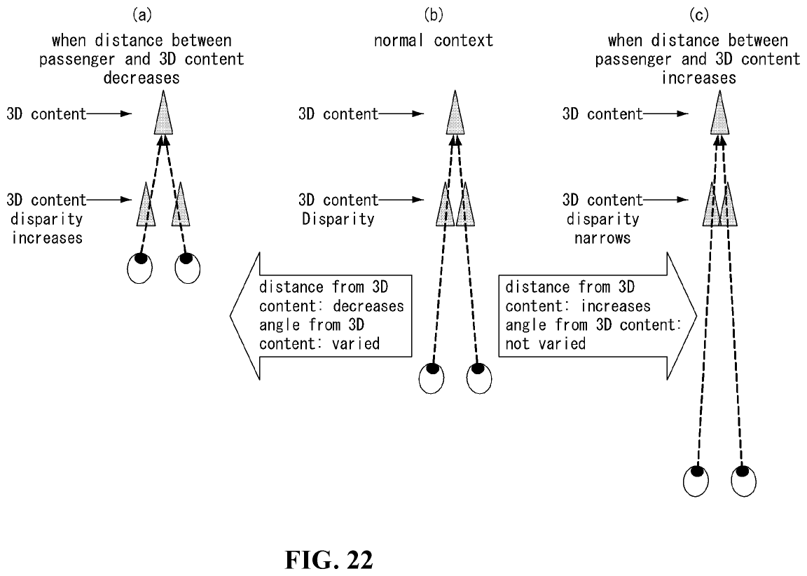

FIGS. 21 and 22 are views illustrating an example method for changing the depth of 3D content according to an embodiment of the present disclosure.

Referring to FIGS. 21 and 22, if the first threshold and second threshold are determined by the method described above in connection with FIG. 20, and their corresponding variable data is derived, the depth of 3D content may be varied depending on the derived variable data.

Specifically, if the convergence distance does not match the adjustment distance upon viewing 3D content as shown in FIG. 21(a), the user may feel dizzy or carsick.

The convergence distance refers to the process of the user's two eyes moving in opposite directions to obtain a single merged image for a specific object, meaning a distance at which the images individually obtained for the specific object by the two eyes become a single merged image.

In other words, the convergence distance means a distance for obtaining a single image for a specific object via the two eyes, and this may be varied depending on the degree of disparity between the two eyes.

Adjustment means changing the shape and thickness of the eye lens to focus on an object positioned in a specific distance, and the adjustment distance means the actual distance between the two eyes and the specific object (e.g., the display playing 3D content).

If the adjustment distance does not match the convergence distance as shown in FIG. 21(a), the passenger's degree of dizziness and/or degree of carsickness may increase.

Thus, the variable data may be altered to reduce the distance of the disparity for the specific object as shown in FIG. 21(b), and it is possible to match the adjustment distance with the convergence distance by applying the altered data as shown in FIG. 21(c).

Specifically, if the distance between the passenger and the 3D content increases in the normal context as shown in FIG. 22(b), the disparity interval may reduce as shown in FIG. 22(a). If the distance between the passenger and the 3D content decreases as shown in FIG. 22(c), the disparity interval may increase.

In other words, the variable data corresponding to the first threshold and second threshold derived by the method described above in connection with FIG. 20 may be applied to the first prediction data and second prediction data.

In this case, the variable data may be applied until the first prediction data is identical to or smaller than the first threshold and the second prediction data is identical to or smaller than the second threshold.

Such a method may provide 3D content to the passenger without causing dizziness or carsickness even while the autonomous vehicle is driving.

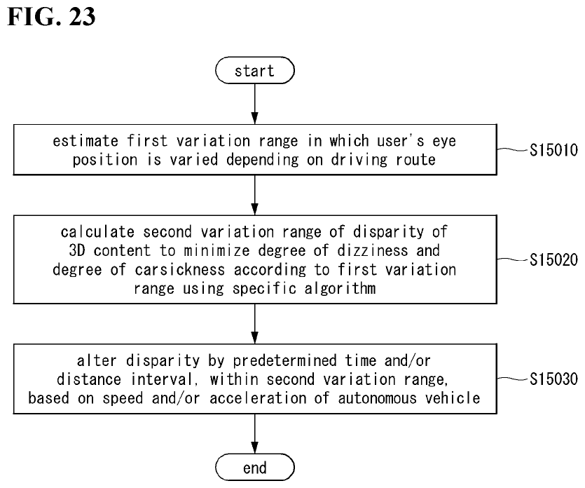

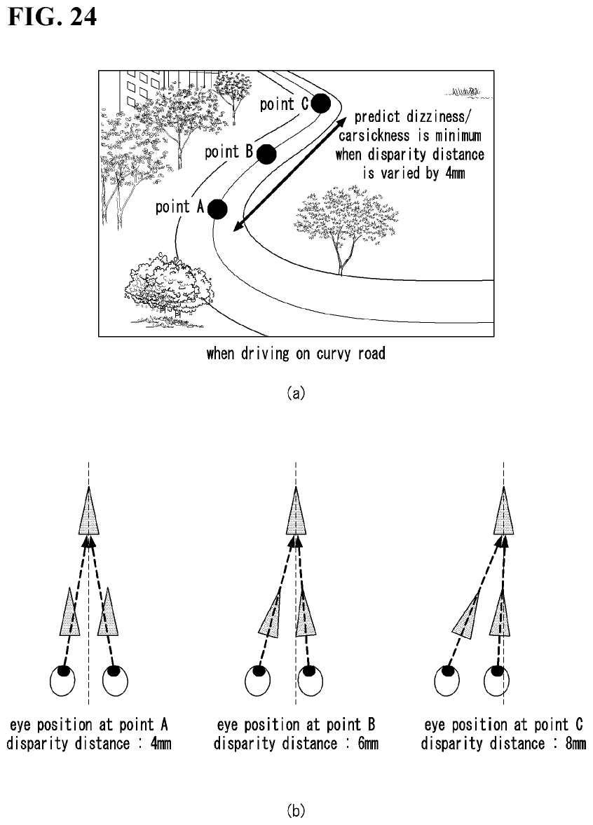

FIGS. 23 and 24 are views illustrating an example method for changing the depth of 3D content depending on a driving route and driving state of an autonomous vehicle according to an embodiment of the present disclosure.

Referring to FIGS. 23 and 24, the depth of 3D content may be varied depending on the driving route and driving plan of the autonomous vehicle.

First, it is assumed that the AI model has been trained with an existing database.

Specifically, in order to vary the depth of 3D content depending on the driving route or driving plane of the vehicle, if there is a curvy road on the driving route or the eye position may be frequently varied, a first variation range in which the position of the user's eye is variable depending on the driving route may be estimated (S23010).

Then, a second variation range of the disparity of 3D content may be obtained for minimizing the degree of dizziness and degree of carsickness according to the first variation range via the AI model trained with the existing database using a specific algorithm (S23020).

The disparity may be varied within the second variation range by a predetermined time and/or a predetermined distance based on the speed and/or acceleration of the autonomous vehicle, based on the obtained second variation range (S23020).

In other words, if the driving route of the vehicle has a curvy road within the second variation range, the disparity may be varied by a predetermined interval based on at least one of the curvy road, acceleration, or speed.

For example, if the driving route of the autonomous vehicle has a curvy road with point A, point B, and point C as shown in FIG. 24(a), the autonomous vehicle may adjust the disparity distance by altering the variable data depending on the eye position by a predetermined interval from point A to thereby adjust the disparity distance. Thus, it is possible to adjust the first prediction data and second prediction data to correspond to the first threshold and second threshold obtained via the AI model.

In other words, the depth of 3D content may be adjusted by adjusting the disparity distance according to the point of the curvy road by the predetermined interval.

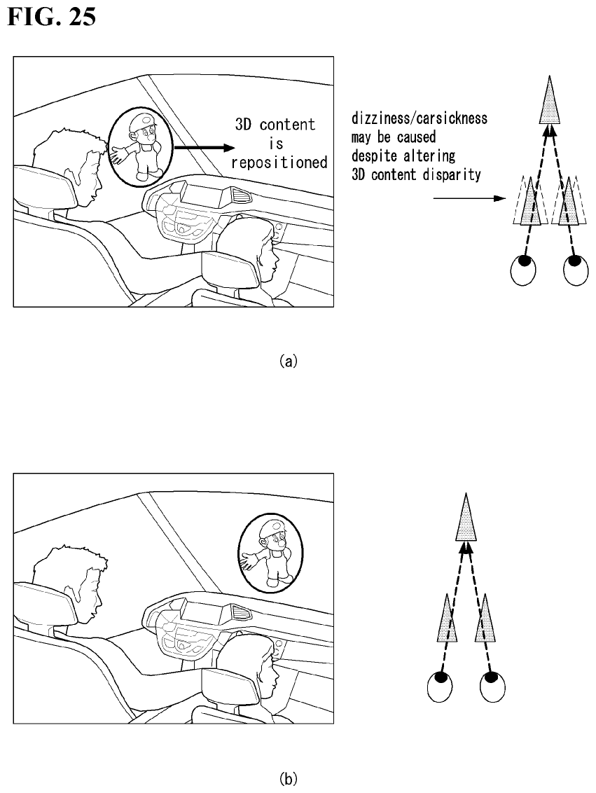

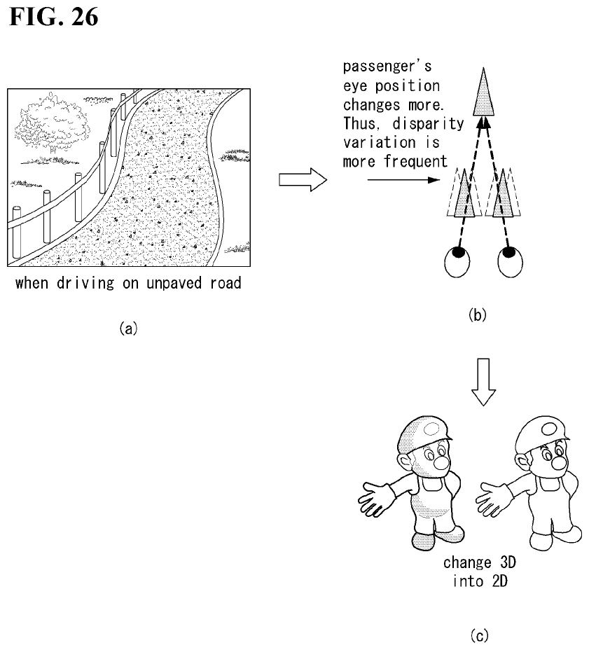

FIGS. 25 and 26 are views illustrating an example method for changing a position for playing 3D content or 3D content to 2D content depending on a user's state according to an embodiment of the present disclosure.

Referring to FIGS. 25 and 26, upon failure to minimize the dizziness or carsickness due to the 3D content while driving on the driving route even with the AI model, the autonomous vehicle may change the position of the 3D content or change the 3D content into 2D content.

Specifically, if the first threshold and second threshold are not derived despite entering the user data to the AI model as shown in FIG. 25(a), the autonomous vehicle may change the position of output of the 3D content.

In other words, if the variation in disparity is frequent so that the passenger's dizziness or carsickness does not reduce despite altering the disparity of 3D content as shown in FIG. 25(a), the 3D content may be provided via other display in the vehicle as shown in FIG. 25(b) and, at this time, the notification that the output position of 3D content has been changed and the output position may be displayed on the display in use.

Or, if the vehicle vibrates or shakes more (a) and, thus, the disparity is varied too frequently (b), it is not easy to prevent the passenger from dizziness and/or carsickness despite changing to the optimal depth of 3D content via the AI model.

In this case, the 3D content may be changed into 2D content that may then be output to avoid the passenger's dizziness or carsickness.

As such, even when the variation in disparity is quite frequent, the passenger's dizziness or carsickness may be minimized by altering the position of 3D content or how to provide the 3D content.

Embodiments of the disclosure

Embodiment 1: A method for providing content by an autonomous vehicle in an autonomous driving system comprises measuring user data for playing three-dimensional (3D) content, the user data including at least one of a position of the user's eye, a first distance between the eye position and the 3D content, a second distance between the eye position and an output device playing the 3D content, an angle between the eye position and the output device, and a type of the 3D content, estimating first prediction data indicating a degree of dizziness predicted for the user and second prediction data indicating a degree of carsickness predicted for the user, using a specific algorithm based on the user data, adjusting a depth of the 3D content when the first prediction data is larger than a first threshold or the second prediction data is larger than a second threshold, and playing the 3D content via the output device based on the adjusted depth, wherein the first threshold indicates a minimum degree of dizziness at which the user feels dizzy, and the second threshold indicates a minimum degree of carsickness at which the user feels carsick.

Embodiment 2: In embodiment 1, the depth is adjusted until the first prediction data is smaller than the first threshold, and the second prediction data is smaller than the second threshold.

Embodiment 3: In embodiment 1, the depth is adjusted to allow an adjustment distance indicating an actual distance between the eye and the 3D content to match a convergence distance indicating a distance for focusing the eye on the 3D content.

Embodiment 4: In embodiment 3, the convergence distance and the adjustment distance are adjusted by altering a disparity of the 3D content.

Embodiment 5: In embodiment 4, the disparity is altered by changing at least one of the first distance, the second distance, or the angle.

Embodiment 6: In embodiment 1, the user data includes variable data and invariable data. The variable data includes the first distance, the second distance, and the angle, and the invariable data includes the eye position and the type of the 3D content.

Embodiment 7: In embodiment 1, the specific algorithm is a deep neural network (DNN) algorithm. The DNN algorithm derives the first threshold and the second threshold by repeated learning based on content playback information and user data measured from existing users.

Embodiment 8: In embodiment 1, the depth is varied depending on a driving route and driving plan of the autonomous vehicle.

Embodiment 9: In embodiment 1, the method further comprises estimating a first variation range in which the position of the user's eye is varied according to the driving route, calculating a second variation range of a disparity of the 3D content to minimize the degree of dizziness and the degree of carsickness according to the first variation range using the specific algorithm, and changing the disparity by a predetermined time and/or predetermined distance interval, within the second variation range, based on a speed and/or acceleration of the autonomous vehicle.

Embodiment 10: In embodiment 9, if the disparity is frequently varied or the second variation range is impossible to calculate, the 3D content is changed into two-dimensional (2D) content, or the 3D content is output via a different output device.

Embodiment 11: An autonomous vehicle for providing content in an autonomous driving system comprises a plurality of output devices for playing 3D content, a transmitter and a receiver for communicating with a server, and a processor functionally connected with the transmitter and the receiver, wherein the processor measures user data for playing the 3D content, the user data including at least one of a position of the user's eye, a first distance between the eye position and the 3D content, a second distance between the eye position and an output device playing the 3D content, an angle between the eye position and the output device, and a type of the 3D content, estimates first prediction data indicating a degree of dizziness predicted for the user and second prediction data indicating a degree of carsickness predicted for the user, using a specific algorithm based on the user data, adjusts a depth of the 3D content when the first prediction data is larger than a first threshold or the second prediction data is larger than a second threshold, and plays the 3D content via the output devices based on the adjusted depth, wherein the first threshold indicates a minimum degree of dizziness at which the user feels dizzy, and the second threshold indicates a minimum degree of carsickness at which the user feels carsick.

Embodiment 12: In embodiment 11, the depth is adjusted until the first prediction data is smaller than the first threshold, and the second prediction data is smaller than the second threshold.

Embodiment 13: In embodiment 11, the depth is adjusted to allow an adjustment distance indicating an actual distance between the eye and the 3D content to match a convergence distance indicating a distance for focusing the eye on the 3D content.

Embodiment 14: In embodiment 13, the convergence distance and the adjustment distance are adjusted by altering a disparity of the 3D content.

Embodiment 15: In embodiment 14, the disparity is altered by changing at least one of the first distance, the second distance, or the angle.

Embodiment 16: In embodiment 11, the user data includes variable data and invariable data. The variable data includes the first distance, the second distance, and the angle, and the invariable data includes the eye position and the type of the 3D content.

Embodiment 17: In embodiment 11, the specific algorithm is a deep neural network (DNN) algorithm. The DNN algorithm derives the first threshold and the second threshold by repeated learning based on content playback information and user data measured from existing users.

Embodiment 18: In embodiment 11, the depth is varied depending on a driving route and driving plan of the autonomous vehicle.

Embodiment 19: In embodiment 18, the method further comprises estimating a first variation range in which the position of the user's eye is varied according to the driving route, calculating a second variation range of a disparity of the 3D content to minimize the degree of dizziness and the degree of carsickness according to the first variation range using the specific algorithm, and changing the disparity by a predetermined time and/or predetermined distance interval, within the second variation range, based on a speed and/or acceleration of the autonomous vehicle.

Embodiment 20: In embodiment 19, if the disparity is frequently varied or the second variation range is impossible to calculate, the 3D content is changed into two-dimensional (2D) content, or the 3D content is output via a different output device.

According to an embodiment of the present disclosure, a method and apparatus for playing content by an autonomous vehicle in an autonomous driving system provide the following effects.

The disclosure may minimize the user's degree of dizziness and degree of carsickness by monitoring the passenger's position to adjust, e.g., the playback position of 3D content.

Further, the disclosure may adjust the position of 3D content and the playback method depending on the angle and position of the user's eyes for viewing 3D content using accrued data for passengers, thereby minimizing the dizziness and/or carsickness the passengers may feel while viewing 3D content in the vehicle.

In the embodiments described above, the components and the features of the present disclosure are combined in a predetermined form. Each component or feature should be considered as an option unless otherwise expressly stated. Each component or feature may be implemented not to be associated with other components or features. Further, the embodiment of the present disclosure may be configured by associating some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

What is claimed is:

1. A method for providing content by an autonomous vehicle in an autonomous driving system, the method comprising:
measuring user data for playing three-dimensional (3D) content, the user data including at least one of a position of the user's eye, a first distance between the eye position and the 3D content, a second distance between the eye position and an output device playing the 3D content, an angle between the eye position and the output device, and a type of the 3D content;
estimating first prediction data indicating a degree of dizziness predicted for the user and second prediction data indicating a degree of carsickness predicted for the user, using a specific algorithm based on the user data;
adjusting a depth of the 3D content when the first prediction data is larger than a first threshold or the second prediction data is larger than a second threshold; and
playing the 3D content via the output device based on the adjusted depth,
wherein the first threshold indicates a minimum degree of dizziness at which the user feels dizzy, and the second threshold indicates a minimum degree of carsickness at which the user feels carsick.

2. The method of claim 1, wherein the depth is adjusted until the first prediction data is smaller than the first threshold, and the second prediction data is smaller than the second threshold.

3. The method of claim 1, wherein the depth is adjusted to allow an adjustment distance indicating an actual distance between the eye and the 3D content to match a convergence distance indicating a distance for focusing the eye on the 3D content.

4. The method of claim 3, wherein the convergence distance and the adjustment distance are adjusted by altering a disparity of the 3D content.

5. The method of claim 4, wherein the disparity is altered by changing at least one of the first distance, the second distance, or the angle.

6. The method of claim 1, wherein the user data includes variable data and invariable data, wherein the variable data includes the first distance, the second distance, and the angle, and wherein the invariable data includes the eye position and the type of the 3D content.

7. The method of claim 1, wherein the specific algorithm is a deep neural network (DNN) algorithm, and wherein the DNN algorithm derives the first threshold and the second threshold by repeated learning based on content playback information and user data measured from existing users.

8. The method of claim 1, wherein the depth is varied depending on a driving route and driving plan of the autonomous vehicle.

9. The method of claim 8, further comprising:
estimating a first variation range in which the position of the user's eye is varied according to the driving route;
calculating a second variation range of a disparity of the 3D content to minimize the degree of dizziness and the degree of carsickness according to the first variation range using the specific algorithm; and
changing the disparity by a predetermined time and/or predetermined distance interval, within the second variation range, based on a speed and/or acceleration of the autonomous vehicle.

10. The method of claim 9, further comprising:
if the disparity is frequently varied or the second variation range is impossible to calculate, the 3D content is changed into two-dimensional (2D) content, or the 3D content is output via a different output device.

11. An autonomous vehicle for providing content in an autonomous driving system, the autonomous vehicle comprising:
a plurality of output devices for playing 3D content;
a transmitter and a receiver for communicating with a server; and
a processor functionally connected with the transmitter and the receiver, wherein the processor:
measures user data for playing the 3D content,
the user data including at least one of a position of the user's eye, a first distance between the eye position and the 3D content, a second distance between the eye position and an output device playing the 3D content, an angle between the eye position and the output device, and a type of the 3D content;
estimates first prediction data indicating a degree of dizziness predicted for the user and second prediction data indicating a degree of carsickness predicted for the user, using a specific algorithm based on the user data;
adjusts a depth of the 3D content when the first prediction data is larger than a first threshold or the second prediction data is larger than a second threshold; and
plays the 3D content via the output devices based on the adjusted depth,
wherein the first threshold indicates a minimum degree of dizziness at which the user feels dizzy, and the second threshold indicates a minimum degree of carsickness at which the user feels carsick.

12. The autonomous vehicle of claim 11, wherein the depth is adjusted until the first prediction data is smaller than the first threshold, and the second prediction data is smaller than the second threshold.

13. The autonomous vehicle of claim 11, wherein the depth is adjusted to allow an adjustment distance indicating an actual distance between the eye and the 3D content to match a convergence distance indicating a distance for focusing the eye on the 3D content.

14. The autonomous vehicle of claim 13, wherein the convergence distance and the adjustment distance are adjusted by altering a disparity of the 3D content.

15. The autonomous vehicle of claim 14, wherein the disparity is altered by changing at least one of the first distance, the second distance, or the angle.

16. The autonomous vehicle of claim 11, wherein the user data includes variable data and invariable data, wherein the variable data includes the first distance, the second distance, and the angle, and wherein the invariable data includes the eye position and the type of the 3D content.

17. The autonomous vehicle of claim 11, wherein the specific algorithm is a deep neural network (DNN) algorithm, and wherein the DNN algorithm derives the first threshold and the second threshold by repeated learning based on content playback information and user data measured from existing users.

18. The autonomous vehicle of claim 11, wherein the depth is varied depending on a driving route and driving plan of the autonomous vehicle.

19. The autonomous vehicle of claim 18, wherein the processor:
estimates a first variation range in which the position of the user's eye is varied according to the driving route;
calculates a second variation range of a disparity of the 3D content to minimize the degree of dizziness and the degree of carsickness according to the first variation range using the specific algorithm; and
changes the disparity by a predetermined time and/or predetermined distance interval, within the second variation range, based on a speed and/or acceleration of the autonomous vehicle.

20. The autonomous vehicle of claim 19, wherein if the disparity is frequently varied or the second variation range is impossible to calculate, the 3D content is changed into two-dimensional (2D) content, or the 3D content is output via a different output device.
